(19) United States
(12) Patent Application Publication
(10) Pub. No.: US 2019/0213242 A1
(43) Pub. Date: Jul. 11, 2019

(54) TECHNIQUES FOR AUTO-POPULATING FORM INPUT FIELDS OF AN APPLICATION

(71) Applicant: Microsoft Technology Licensing, LLC, Redmond, WA (US)

(72) Inventors: Rajeev Ranjan Pathak, Hyderabad (IN); Arif Alam Siddique, Hyderabad (IN); Akshay Jayant Prabhu, Hyderabad (IN); Gowthami Chegu, Hyderabad (IN); Umesh Bhardwaj, Hyderabad (IN); Mohit, Hyderabad (IN); Vivek Kumar, Hyderabad (IN); Anoop Pandey, Hyderabad (IN); Vasanth Raja, Hyderabad (IN); Sonia Singh, Bangalore (IN); Ankit Kumar Agrawal, Hyderabad (IN)

(21) Appl. No.: 15/868,498

(22) Filed: Jan. 11, 2018

(51) Int. Cl. G06F 17/24; G06F 17/27

(52) U.S. Cl. CPC G06F 17/243; G06F 3/0482; G06F 17/276

(57) ABSTRACT

Described are examples for populating input fields on an application. A form input field of a form rendered by an application can be detected by the application, or another application. A data class associated with the form input field can be determined, and an anticipatory response for populating the form input field can be determined based on the data class and input from one or more different applications. The form input field of the form can be populated, via the application, with the anticipatory response.

### BACKGROUND

Web browsers typically include auto-fill functionality where data initially entered for form input fields on forms rendered in the web browser are stored and subsequently used to auto-fill data for form input fields on other forms generated by the web browser. The auto-fill functionality stores input for a given form input field along with a name of the field or an associated label indicated on the form. The auto-fill functionality then generates prompts on a subsequent form where a form input field on the subsequent form has a same or similar name or label as the stored form input field. In addition, some auto-fill functions also associate groups of data input on multiple form input fields (e.g., such as name, address, city, state, and zip code) so that selecting a prompt to auto-fill one form input field can result in auto-filling multiple form input fields with values for the associated groups of data.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

In an example, a method for populating input fields on an application is provided.

The method includes detecting, via the application, a form input field of a form rendered by the application, determining a data class associated with the form input field, generating, based on the data class and input from one or more different applications, an anticipatory response for populating the form input field, and populating, via the application, the form input field of the form with the anticipatory response.

In another example, a device for populating input fields on an application is provided. The device includes a memory storing one or more parameters or instructions for generating anticipatory responses for form input fields, and at least one processor coupled to the memory. The at least one processor is configured to detect, via the application, a form input field of a form rendered by the application, determine a data class associated with the form input field, generate, based on the data class and input from one or more different applications, an anticipatory response for populating the form input field, and populate, via the application, the form input field of the form with the anticipatory response.

In another example, a computer-readable medium, including code executable by one or more processors for populating input fields on an application is provided. The code includes code for detecting, via the application, a form input field of a form rendered by the application, determining a data class associated with the form input field, generating, based on the data class and input from one or more different applications, an anticipatory response for populating the form input field, and populating, via the application, the form input field of the form with the anticipatory response.

To the accomplishment of the foregoing and related ends, the one or more implementations comprise the features hereinafter fully described and particularly pointed out in the claims. The following description and the annexed drawings set forth in detail certain illustrative features of the one or more implementations. These features are indicative, however, of but a few of the various ways in which the principles of various implementations may be employed, and this description is intended to include all such implementations and their equivalents.

### BRIEF DESCRIPTION OF THE DRAWINGS

FIG. 1 is a schematic diagram of an example of a device that can generate anticipatory response for auto-filling form input fields in accordance with examples described herein.

FIG. 2 is a flow diagram of an example of a method for populating form input fields in accordance with examples described herein.

FIG. 3 is a flow diagram of an example of a method for storing input data in an auto-fill repository in accordance with examples described herein.

FIG. 4 is a flow diagram of an example of a method for managing input data stored in an auto-fill repository in accordance with examples described herein.

FIG. 5 is a schematic diagram of an example of a device for performing functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to providing auto-fill functionality to automatically populate form input fields rendered by applications executing on a computing device. Conventional auto-fill functionality operates based on detecting field name or tag, and determining whether a previous form input field with the same name was filled with input data on a previous form rendered by the application (and thus at least requires an initial entry of the input data on a form). In addition, conventional auto-fill functionality stores input data for fields for a period of time that is agnostic to the type of data. Examples described herein provide an auto-fill functionality that can provide an anticipatory response to form input fields (e.g., even when a form input field of the same name has not yet been initially filled). In addition, examples described herein provide an auto-fill functionality that can generate data for input for the form input field based on identifying a data class associated with the field (e.g., as opposed to only the field name or label). Moreover, examples described herein provide an auto-fill functionality that can provide input having a transient property, such that the stored input data can be expired or otherwise removed from storage based on one or more detected events relevant to the data (e.g., an ending of a browser session, expiration of a period of time or determined shelf life associated with the data, etc.).

In an example, an auto-fill application can detect a form input field rendered by another application on a computing device, and can determine an anticipatory response as auto-fill data for the form input field. For example, the auto-fill application can determine a data class associated with the form input field, and can determine whether one or more input data responses are stored or can be generated based on the data class. In an example, the auto-fill application can obtain data related to the data class from one or more other applications, such as a productivity application (e.g., calendar, contacts, email, etc.), a web mining application that can mine web data for certain inputs, such as coupon codes or other offers, etc., a web browser used to input other data in other forms, etc. Thus, for example, the auto-fill application can associate certain types of data in a class, where the data can be obtained from one or more of these other applications, can determine a data class of a form input field of a form presented on an application, such as a web browser application, and can provide an anticipatory response for a form input field on the web browser based on determining the data class related to the form input field and the obtained input data for the data class. In this regard, in one example, an anticipatory response can be generated for a form input field that has not had a previously filled input.

In another example, the auto-fill application can associate a transient property with auto-fill data, whether the auto-fill data corresponds to generated anticipatory responses or input data actually input (e.g., filled by a user and/or machine) into the form input fields. For example, the auto-fill application can remove auto-fill data based on one or more detectable events associated with the auto-fill data, associated with a data class corresponding to the auto-fill data, associated with a value of the auto-fill data itself, etc. For example, the auto-fill application can assign application-based events, such as exiting a session, with some auto-fill data to cause removal thereof when the event occurs. In another example, the auto-fill application can associate time-based events, such as an expiration time, with some auto-fill data to cause deletion thereof when the time is reached. This can provide for more intelligent auto-fill behavior, where some values may be removed from auto-fill when they are no longer relevant.

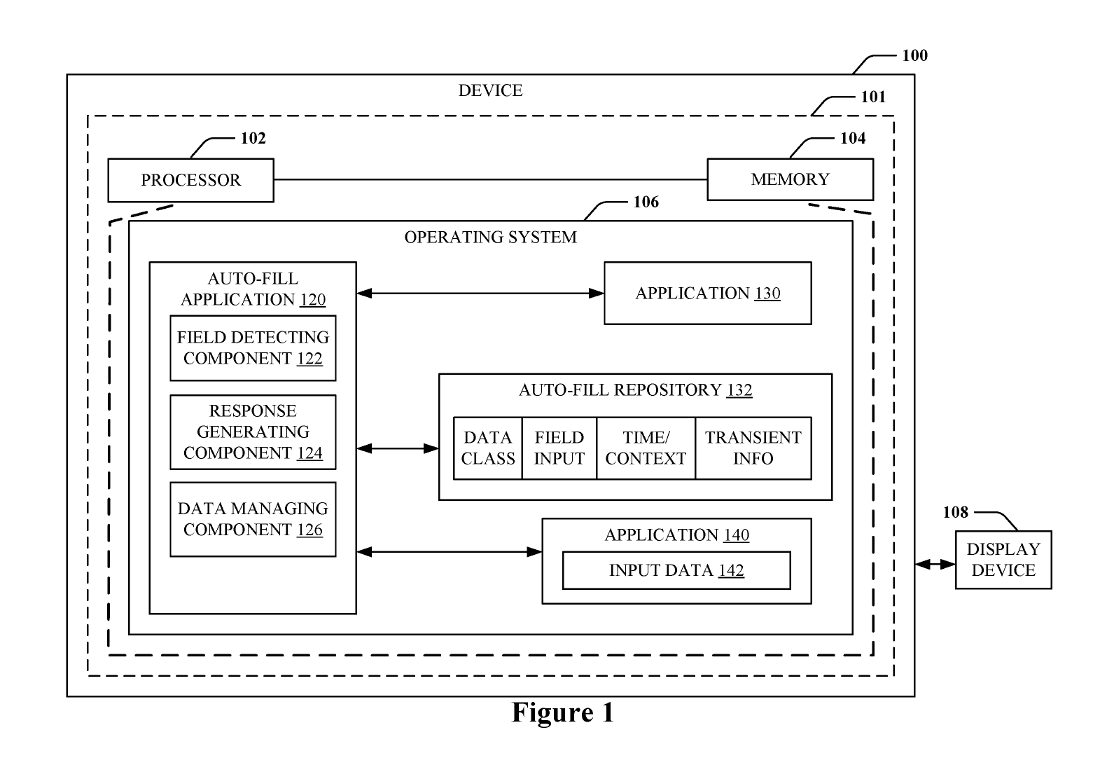

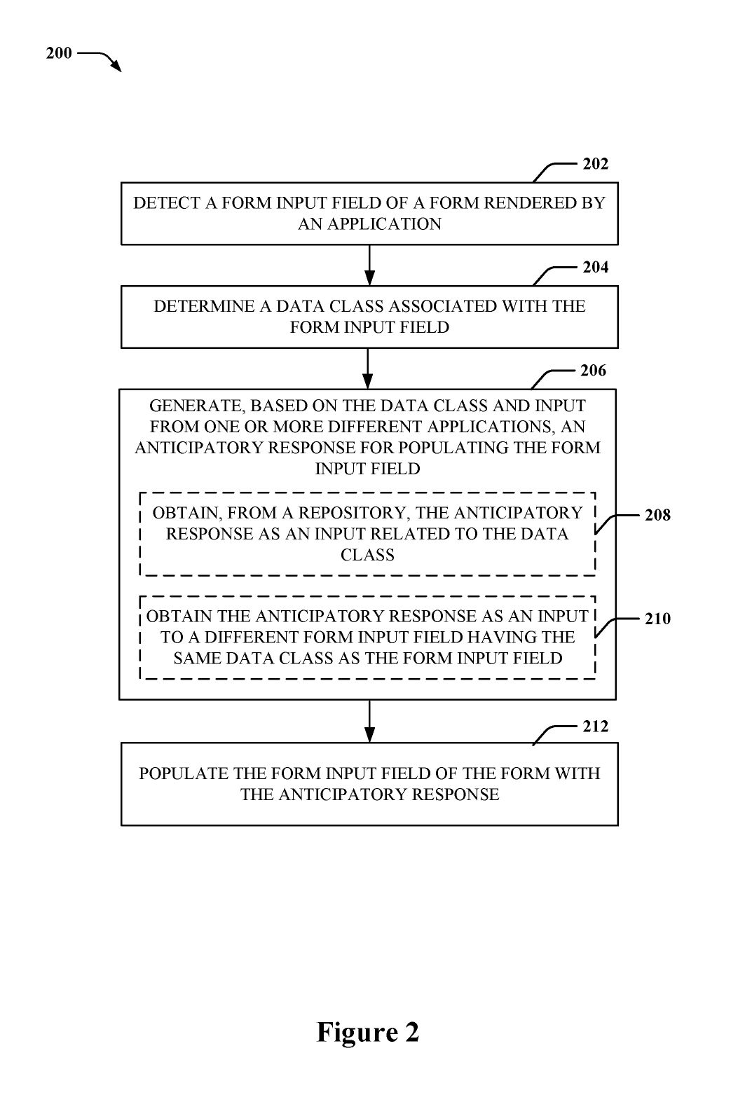

Turning now to FIGS. 1-5, examples are depicted with reference to one or more components and one or more methods that may perform the actions or operations described herein, where components and/or actions/operations in dashed line may be optional. Although the operations described below in FIGS. 2-4 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of a device 100 (e.g., a computing device) that can provide auto-population functionality for form input fields in one or more applications. In an example, device 100 can include a processor 102 and/or memory 104 configured to execute or store instructions or other parameters related to providing an operating system 106, which can execute one or more applications 120, 130, 140, services, etc. For example, processor 102 and memory 104 may be separate components communicatively coupled by a bus (e.g., on a motherboard or other portion of a computing device, on an integrated circuit, such as a system on a chip (SoC), etc.), components integrated within one another (e.g., processor 102 can include the memory 104 as an on-board component 101), and/or the like. Memory 104 may store instructions, parameters, data structures, etc., for use/execution by processor 102 to perform functions described herein, such as auto-fill repository 132.

In addition, for example, device 100 may be communicatively coupled to one or more display devices 108 which may include liquid crystal display (LCD) devices, light emitting diode (LED) LCD devices (e.g., having an LED backlight), digital light processing (DLP) display, or substantially any display, etc. The display device 108 can display images generated and provided by the device 100 via operating system 106, applications 120, 130, 140, executing thereon, etc., as described further herein.

Operating system 106 may execute an auto-fill application 120 configured to detect form input fields on other applications, such as application 130, executing on the operating system 106, and determine input data for automatically populating in the form input field (e.g., or for populating as selectable options in a dropdown list for the form input field) based on one or more characteristics of the field, data stored in an auto-fill repository 132, etc. In an example, the auto-fill application 120 can be a part of the application 130 on which the form input field is detected, though in other examples, the auto-fill application 120 may execute independently and may be able to detect form input fields rendered by the application 130. In any case, the auto-fill application 120 can determine properties of the form input field(s) and can provide values for auto-populating the field, an associated dropdown list of selectable values, etc., based at least in part on the properties of the field.

In an example, auto-fill application 120 can include a field detecting component 122 configured to detect a form input field rendered by an application 130 and/or one or more properties of the form input field, a response generating component 124 configured to generate auto-fill data, such as an anticipatory response, for the form input field based on the one or more properties and/or input data stored in an auto-fill repository 132, and/or a data managing component 126 for managing the input data stored in the auto-fill repository 132. In one example, data managing component 126 can generate data for the auto-fill repository 132 based on receiving input data 142 from other applications 140, mining other applications 140 for input data 142, etc. For instance, data managing component 126 can obtain input data 142, determine a data class related to the input data, and store the input data in auto-fill repository 132 as field input corresponding to the data class. In addition, in an example, data managing component 126 can associate transient information with the input data for managing a lifetime of the input data within the auto-fill repository 132. For example, the transient information may relate to a time or one or more events for deleting the data from the auto-fill repository 132, and may include a date and/or time at or by which to delete the data from the auto-fill repository 132. In another example, the one or more events may include closing of a web browser or other application or thread of execution associated with the data, etc. In any case, data managing component 126 may use the transient information to manage the auto-fill repository 132 such to automatically delete or otherwise manage the data based on detecting the date/time, event, etc. associated with the data.

In an example, field detecting component 122 can detect a form input field on application 130, and response generating component 124 can obtain input data from the auto-fill repository 132 that corresponds to a data class or other characteristic of the form input field, as described further herein. Response generating component 124 can accordingly provide the input data to the application 130 for populating the form input field. In another example, data managing component 126 can obtain the input data 142 from the other application 140 based on detecting the form input field. In one example, application 130 and application 140 can be the same application, different outputs from the same application (e.g., different webpages visited by a web browser), different applications altogether that execute independently via operating system 106, etc., as described herein. For example, application 140 can be one webpage rendered by a web browser, while application 130 can be another webpage rendered by the same or different web browser. In another example, application 140 may include a productivity application (e.g., with email, a calendar, a contact list, etc.) from which input data 142 can be determined. In yet another example, application 140 may include a data mining application for mining data on the device 100, on the internet, etc., as described herein.

In any case, multiple types of input data can be obtained by application 140 and associated with different data classes as possible auto-fill data. For example, data managing component 126 can associate the input data 142 with a data class based on a label, field name, determinable data type, etc. from the application 140. This can enable the response generating component 124 to detect a data class of a form input field for determining possible auto-fill data from the auto-fill repository 132 based on determining similarities between the detected data class and/or a data class associated with field input data in the auto-fill repository 132. Data managing component 126 can also, in an example, associate different input data with one another in a group of input data corresponding to an instance. In one example, the association may be by data class, by time/event, or may include another association identifier, such that for multiple input fields, the response generating component 124 may obtain the associated data (e.g., by data class or time/event) as auto-fill candidates for each of the multiple input fields.

FIG. 2 is a flowchart of an example of a method 200 for auto-populating a form input field. For example, method 200 can be performed by a device 100, and/or one or more components thereof, to determine data for automatically populating a form input field.

In method 200, at action 202, a form input field of a form rendered by an application can be detected. In an example, field detecting component 122, e.g., in conjunction with processor 102, memory 104, operating system 106, auto-fill application 120, etc., can detect the form input field of the form rendered by the application, such as application 130. For example, application 130 can display forms for obtaining input from a user operating device 100. Application 130 may be a web browser that can receive and display web forms (e.g., forms defined on webpages using hypertext markup language (HTML)). Application 130 can be substantially any other type of application as well, so long as auto-fill application 120 can access and provide possible auto-fill input for form input fields on forms presented by the application 130. For example, application 130 can cause display of a form on display device 108, and auto-fill application 120, which can execute as a service on the operating system 106, a plug-in for the application 130, etc., can detect the form from the application 130 and/or one or more form input fields on the form. In one example, this can include detecting HTML tags or other programming language identifiers that indicate existence of a form and/or corresponding form input fields. In another example, field detecting component 122 may detect a field (or an associated field name or label) using optical character recognition on the form displayed by display device 108.

In method 200, at action 204, a data class associated with the form input field can be determined. In an example, response generating component 124, e.g., in conjunction with processor 102, memory 104, operating system 106, auto-fill application 120, etc., can determine the data class associated with the form input field. For example, response generating component 124 can determine the data class associated with the form input field based on analyzing a field name or label associated with the form input field or other contextual information discerned from the form. The data class can be of substantially any level of specificity, and thus may include a general class of the field, additional contextual information such as a type of the form or application 130, input data from other fields filled on the form, etc. Thus, for example, the data class may be name, address, departure city (e.g., for a travel application), departure date, etc., or may be more specific, such as an address associated with an input name, a departure city associated with an input departure date, etc. In the latter example, input of the other form data (e.g., departure date) can cause determination of the class associated with the form input field (e.g., departure city). For example, where departure date is input to the form, response generating component 124 can determine the data class for departure city as being departure city for date of travel of the departure date.

In method 200, at action 206, based on the data class and input from one or more different applications, an anticipatory response for populating the form input field can be determined. In an example, response generating component 124, e.g., in conjunction with processor 102, memory 104, operating system 106, auto-fill application 120, etc., can generate, based on the data class and input from one or more different applications (e.g., application 140), an anticipatory response for populating the form input field. As described, anticipatory responses for the form input fields can be generated based on data from other application, such as application 140. For example, application 140 can have associated input data 142, which can be correlated with a data class based on one or more parameters of the input data 142 (e.g., a field name, label, etc. on the form, time/date information, type of the application 140 and/or corresponding form, etc.). In addition, for example, auto-fill application 120 may store auto-fill data for form input fields including data input used in populating different form input fields of the same form input field type (e.g., via the application 130 and/or other applications), and response generating component 124 can generate the anticipatory response based on first determining that the stored auto-fill data does not include data input for a form input field type of the form input field.

Application 140 can include a web page rendered on a web browser or other applications on the device 100 from which input for form input fields can be obtained. In one example, application 140 can include a productivity application that can store email, calendar, task, etc. information, from which possible form input data 142 can be discerned. In another example, application 140 can include a data mining application that can mine for data on the device 100, data on the internet, etc. for possible input data 142 for form input fields. In one example, application 140 may execute to locate input data 142 for a form input field based on information input into other form input fields or other data of the form. For example, application 140 can mine the internet (or email from the productivity application, etc.) for coupon codes for a vendor as anticipatory response to a coupon code form input field based on detecting the form input field associated with a coupon code data class and based on detecting the vendor name on the form. In any case, input data 142 can be determined from the application 140 when received at the application 140, based on mining for the data, etc., and stored into auto-fill repository 132, as described further herein, and/or can be obtained when the response generating component 124 determines the data class associated with the form input fields, etc.

Generating the anticipatory response at action 206 may optionally include, at action 208, obtaining, from a repository, the anticipatory response as an input related to the data class. In an example, response generating component 124, e.g., in conjunction with processor 102, memory 104, operating system 106, auto-fill application 120, etc., can obtain, from the repository (e.g., auto-fill repository 132), the anticipatory response as input related to the data class. For example, as described further herein, the auto-fill repository 132 may be populated with anticipatory response data at various instances in time and/or based on input data 142 from various applications 140 to facilitate determining anticipatory response data for form input fields based on data class of the form input field, a time/context associated with the form input field, etc. In this regard, response generating component 124 can query the auto-fill repository 132 based on aspects of the form input field, aspects of other input data in other form input fields, aspects of the application 130 or related form, etc., to obtain one or more possible anticipatory responses for the form input field.

In one example, response generating component 124 can receive multiple possible anticipatory responses for a form input field and may select one or rank the multiple possible responses based on one or more aspects thereof stored in the auto-fill repository 132. For example, response generating component 124 can select one of, or rank, the multiple possible anticipatory responses based on the associated time/context information. For example, this may include response generating component 124 selecting or ranking anticipatory response(s) based on a date/time the input data 142 corresponding to the anticipatory response was input into the auto-fill repository, or into application 140), such that more recently input data 142 can be selected or displayed first in an ordered list. In another example, this may include response generating component 124 selecting or ranking anticipatory response(s) based on other input data in other form input fields on the application 140 or a type of the application 140, which may provide the context information, etc., and comparing the context information to a determined context of the form input field of the application 130. In one example, the data class may support a level of specificity to provide the context information in addition or alternatively to separately stored time/context information in the auto-fill repository 132.

In another example, generating the anticipatory response at action 206 may optionally include, at action 210, obtaining the anticipatory response as an input to a different form input field having the same data class as the form input field. In an example, response generating component 124, e.g., in conjunction with processor 102, memory 104, operating system 106, auto-fill application 120, etc., can obtain the anticipatory response as an input to a different form input field having the same data class as the form input field. For example, application 140 can have received an input to a form input field having a data class, though the field name or label associated with the input field may be different, and/or the application 140 may be different from the application 130. For example, application 140 may obtain input data 142 corresponding to a calendar date for a booked flight, and may associate the calendar date with a data class of travel date (or specifically departure date and return date). Response generating component 124 can generate an anticipatory response for a form input field of application 130 having a data class of travel date (e.g., a departure date on a travel web form) based on determining the travel date from the application 140 has the same data class.

Moreover, as described, response generating component 124 can search the application 140 for possible anticipatory responses based on detecting the form input field of the application 130, and/or can populate auto-fill repository 132 when the input data 142 is input into application 140, etc.

In any case, in method 200, at action 212, the form input field can be populated with the anticipatory response. In an example, auto-fill application 120, e.g., in conjunction with processor 102, memory 104, operating system 106, etc., can populate the form input field (e.g., on application 130) with the anticipatory response. In one example, this can include populating the actual form input field with highlighted text to complete text input by a user, populating a drop down list on the form input field with one or more anticipatory responses, etc. Thus, a user can select one of the anticipatory responses for populating the form input field, saving time from having to type the complete input data. In addition, auto-fill application 120 can auto-fill other form input fields on the form with other anticipatory responses corresponding to the anticipatory response generated by the response generating component 124 and/or corresponding to the selected anticipatory response. In this example, as described, the selected anticipatory response for the form input field, or input data otherwise input into the form input field, can be used to determine anticipatory responses for other form input fields on the form or other forms.

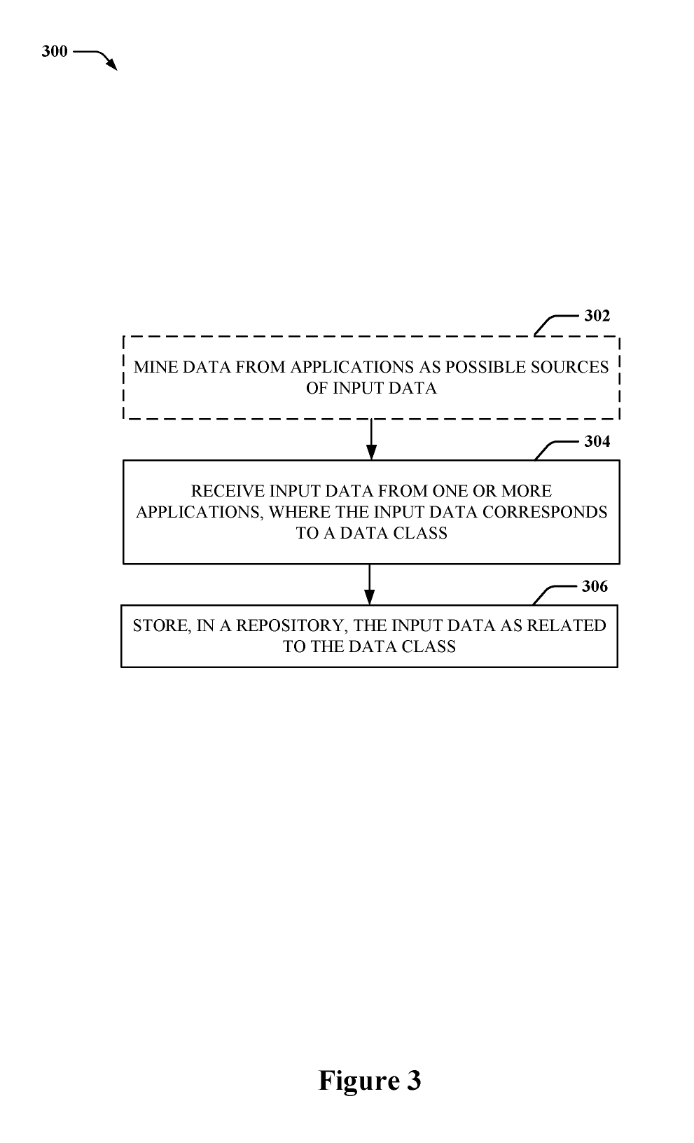

FIG. 3 is a flowchart of an example of a method 300 for storing form input data in a repository for generating anticipatory responses for form input fields. For example, method 300 can be performed by a device 100, and/or one or more components thereof, to determine data for storing in an auto-fill repository.

In method 300, optionally at action 302, data can be mined from an application as possible sources of input data. In an example, data managing component 126, e.g., in conjunction with processor 102, memory 104, operating system 106, auto-fill application 120, etc., can mine data from applications, such as input data 142 or other data from application 140, as possible sources of input data. In one example, data managing component 126 can mine a productivity application for emails, calendar events, etc., that may possibly include input data for anticipatory responses. In examples described above, data managing component 126 can mine the productivity application for travel confirmation emails to obtain possible input data corresponding to departure and/or return cities/dates, tracking information for purchased products, etc. In other examples described above, data managing component 126 can mine other sources, such as the internet, associated web pages, promotional mailers (e.g., in electronic mail), short messaging service (SMS) messages, which may correspond to a user account associated with the computing device 100 and/or application 140, etc., for coupon codes for vendors or products that may be determined as relevant to application 130, etc.

In method 300, at action 304, input data can be received from one or more applications, where the input data corresponds to a data class. In an example, data managing component 126, e.g., in conjunction with processor 102, memory 104, operating system 106, auto-fill application 120, etc., can receive the input data (e.g., input data 142) from one or more applications (e.g., application 140), where the input data corresponds to the data class. For example, data managing component 126 can determine the data from the input data 142 as corresponding to one or more data classes, for storing in auto-fill repository 132. In one example, data managing component 126 can define one or more characteristics of data being sought for storing in the auto-fill repository, such as the data class. For instance, the one or more characteristics may be associated with the data class, such as a field name or label (or multiple field names or labels, logic for determining similar field names/labels, etc.), a data type of the field, a type of the application 140 or associated form, and/or the like. In any case, the data class can be used to determine the input data to be stored, and/or can be determined for the input data in storing the data in the auto-fill repository 132.

In method 300, at action 306, the input data can be stored in the repository as related to the data class. In an example, data managing component 126, e.g., in conjunction with processor 102, memory 104, operating system 106, auto-fill application 120, etc., can store, in the repository (e.g., auto-fill repository 132) the input data as related to the data class. In one example, data managing component 126 can store entries in the auto-fill repository that include the data class, field input data, time/context associated with the data (e.g., a time the data is discovered by the data managing component 126, a time the data is entered into application 140, a type of the application 140 or an associated form, etc.), and/or transient information related to removing or modifying the data in the auto-fill repository 132, such as a shelf-life for the data or an event to cause deletion of the data (as described further herein), etc.

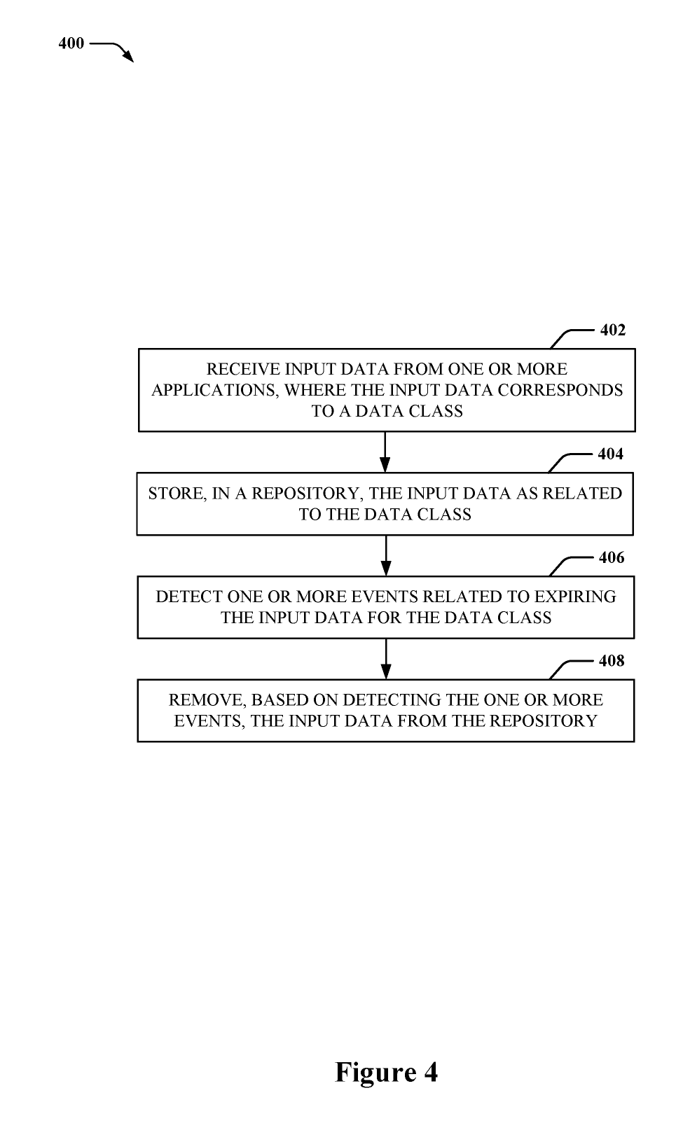

FIG. 4 is a flowchart of an example of a method 400 for managing form input data stored in a repository for generating anticipatory responses for form input fields. For example, method 400 can be performed by a device 100, and/or one or more components thereof, to manage the data stored in the auto-fill repository.

In method 400, at action 402, input data can be received from one or more applications, where the input data corresponds to a data class. In an example, data managing component 126, e.g., in conjunction with processor 102, memory 104, operating system 106, auto-fill application 120, etc., can receive the input data from the one or more applications, where the input data corresponds to the data class. This may be similar to action 304 described with reference to method 300 in FIG. 3.

In method 400, at action 404, the input data can be stored in a repository as related to the data class. In an example, data managing component 126, e.g., in conjunction with processor 102, memory 104, operating system 106, auto-fill application 120, etc., can store, in the repository (e.g., auto-fill repository 132) the input data as related to the data class. This may be similar to action 306 described with reference to method 300 in FIG. 3. In addition, data managing component 126 can store the input data with transient information related to removing the input data from the auto-fill repository 132. The transient information may relate to one or more events whose occurrence may cause deleting the input data from the auto-fill repository 132, such as a date/time at or by which to delete the input data from the auto-fill repository 132, information regarding one or more events (e.g., exiting a web browser) that may cause deletion of the input data from the auto-fill repository 132, etc.

In method 400, at action 406, one or more events related to expiring the input data for the data class can be detected. In an example, data managing component 126, e.g., in conjunction with processor 102, memory 104, operating system 106, auto-fill application 120, etc., can detect the one or more events related to expiring the input data for the data class. For example, data managing component 126 can detect that a date/time associated with deleting the input data, which may be indicated as related to the data in the auto-fill repository 132, is reached. In another example, data managing component 126 can detect one or more events indicated to cause deletion of the input data (e.g., exiting application 130), etc. As described, auto-fill application 120 can operate outside of the application 130, and can detect one or more events based on information received from the application 130 (e.g., via operating system or otherwise), or can operate autonomously in managing the data in auto-fill repository 132 based on detecting dates/times or events associated with the input data.

In method 400, at action 408, the input data can be removed from the repository based on detecting the one or more events. In an example, data managing component 126, e.g., in conjunction with processor 102, memory 104, operating system 106, auto-fill application 120, etc., can remove, based on detecting the one or more events, the input data from the repository (e.g., from auto-fill repository 132). In this regard, once the data is removed, it may no longer be offered as an anticipatory response to a form input field. This may improve applicability of the data presented by the auto-fill application 120 by expiring data that is no longer relevant.

Described below are specific non-limiting examples of operation of the auto-fill application 120 in accordance with components and functions described above in FIGS. 1-4. In one specific example, data managing component 126 can obtain input data 142 from an application 140, such as a productivity application, including travel dates and cities from a confirmation email of airfare booking. Data managing component 126 can store the travel dates and cities in the auto-fill repository 132 along with associated data classes, such as “travel departure date,” “travel return date,” “travel destination city,” etc. In another example, the data classes can be more generic (e.g., “date,” “city,” etc.) with additional context information indicating a time associated with the date and city, an indication of “travel” associated with the date and city, etc. In one example, data managing component 126 can store this information when the email is received, in a mining process for data for the auto-fill repository, etc. Moreover, in an example, data managing component 126 can store the information when entered into an application 140 for booking the flight instead of, or in addition to, the confirmation email, etc.

In this example, field detecting component 122 can detect application 130 presenting a form related to travel, such as a hotel or car rental booking application or website, and can determine one or more form input fields in the application 130. Response generating component 124 can determine a data class of one or more of the form input fields as being a date, city, etc., or more specifically, a travel date, travel city, etc. In this example, response generating component 124 can query auto-fill repository 132 for travel dates, travel cities, etc., and can obtain anticipatory responses from the auto-fill repository 132 in the form of the departure date and destination city previously obtained from the application 140. Response generating component 124 can auto-fill the form input fields on application 130 with the anticipatory responses. In another example, response generating component 124 can obtain anticipatory response data for one form input field (e.g., the destination city) based on first receiving input on another form input field (e.g., the departure date) by an association of the data indicated in the auto-fill repository 132. Thus, auto-fill data can be presented on the application 130, though an initial input of the data may not have occurred specifically via application 130 (but rather is obtained based on data from other applications).

Additionally, in this example, data managing component 126 can store transient information with the travel data, such as a date/time at which the data expires. For example, data managing component 126 can store a date/time corresponding to the departure date/time and/or a return date/time, at which the data can be determined as no longer relevant. When this time occurs, data managing component 126 can remove or otherwise expire the data from the auto-fill repository 132 to prevent the data from being used as anticipatory response for form input fields (e.g., after the travel has occurred). In some examples, this data may be kept in the auto-fill repository 132 (e.g., where it is determined that the destination is a frequent one), and/or a portion of the data may be kept in the auto-fill repository 132 (e.g., the destination city may have different transient information than the associated departure date, such that the destination city can be used as an anticipatory response for other form input fields while the departure date can be expired when it occurs in the past).

In another specific example, data managing component 126 can obtain input data 142 from an application 140, such as a productivity application, including a tracking identifier from a shipping confirmation email for a retail purchase. Data managing component 126 can store the tracking identifier, the carrier, a shipping date, and/or an expected arrival date in the auto-fill repository 132 along with associated data classes, such as “tracking identifier,” “carrier,” “shipping date,” “arrival date,” etc. In another example, the data classes can be more generic (e.g., “tracking identifier,” “date,” etc.) with additional context information indicating an association between the tracking identifier and date, etc. In one example, data managing component 126 can store this information when the email is received, in a mining process for data for the auto-fill repository, etc. Moreover, in an example, data managing component 126 can store the information when provided by the application 140 on a customer service site for shipping tracking, or in addition to, the confirmation email, etc.

In this example, field detecting component 122 can detect application 130 presenting a form related to tracking shipping, such as a shipping service application or website, and can determine one or more form input fields in the application 130. Response generating component 124 can determine a data class of one or more of the form input fields as being a tracking identifier and/or a carrier related to the shipping service application or website. In this example, response generating component 124 can query auto-fill repository 132 for tracking identifiers corresponding to the carrier, and can obtain anticipatory responses from the auto-fill repository 132. Response generating component 124 can auto-fill the form input fields on application 130 with the anticipatory responses.

Additionally, in this example, data managing component 126 can store transient information with the tracking identifier, such as an arrival date (or a certain time thereafter), at which the data expires. For example, data managing component 126 can store a date/time corresponding to the expected arrival time of the shipment, at which the data can be determined as no longer relevant (or at a certain time measured from the expected arrival time). When this time occurs, data managing component 126 can remove or otherwise expire the data from the auto-fill repository 132 to prevent the data from being used as anticipatory response for form input fields (e.g., after the shipment has arrived).

In another specific example, data managing component 126 can obtain input data 142 from an application 140, such as a productivity application, including a shipping address from an order confirmation email for a retail purchase, a shipping address from the application 140 used to create the order, etc. Data managing component 126 can store the shipping address including name, address, city, state, zip code, etc. in the auto-fill repository 132 along with associated data classes and/or additional context information associating the data as a complete shipping address. In one example, data managing component 126 can store this information when the email is received, in a mining process for data for the auto-fill repository, etc.

In this example, field detecting component 122 can detect application 130 presenting a form related to providing shipping information, such as a retail ordering application or website, and can determine one or more form input fields in the application 130. Response generating component 124 can determine a data class of one or more of the form input fields as being a shipping address or various portions thereof In this example, response generating component 124 can query auto-fill repository 132 for the shipping address information. In one example, response generating component 124 can detect at least partial filling of a name for the shipping address, and can obtain anticipatory responses and auto-fill the remaining form input fields for the shipping address based on the partially filled name.

Additionally, in this example, data managing component 126 can store transient information with the shipping address, such as an expiration time, after which the data can be removed from the auto-fill repository 132 if not used again before the expiration time. In this example, when the auto-fill application 120 detects that the data is used by application 130, it can renew the expiration time of the data (e.g., the transient information) in the auto-fill repository 132.

In another specific example, data managing component 126 can obtain input data 142 from an application 140, such as a social networking service, including employment and/or education history. Data managing component 126 can store the employment and/or education history in the auto-fill repository 132 along with associated data classes. In one example, data managing component 126 can store this information when input into the social network service (e.g., when registering an account, updating account registration information, etc.), in a mining process for data for the auto-fill repository, etc.

In this example, field detecting component 122 can detect application 130 presenting a form related to entering employment and/or education history, such as a job searching application or website, and can determine one or more form input fields in the application 130. Response generating component 124 can determine a data class of one or more of the form input fields as relating to employment and/or education history. In this example, response generating component 124 can query auto-fill repository 132 for the employment and/or education history data, and can obtain anticipatory responses from the auto-fill repository 132. Response generating component 124 can auto-fill the form input fields on application 130 with the anticipatory responses.

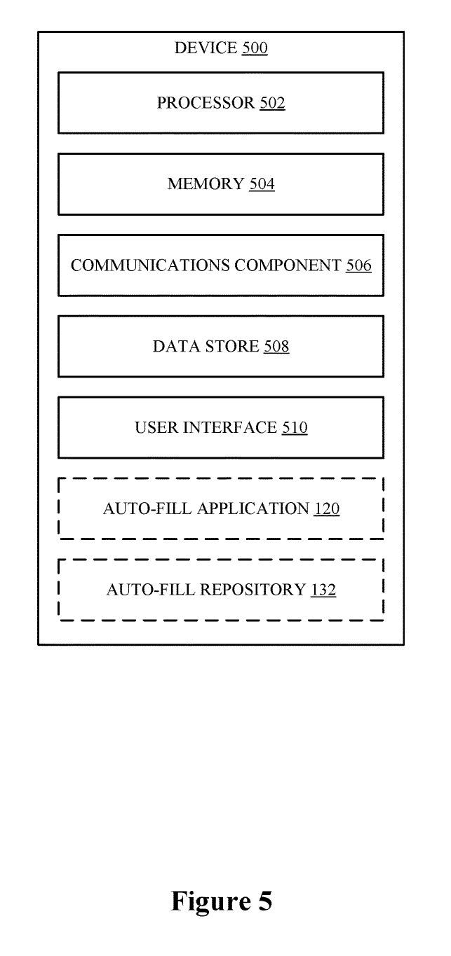

FIG. 5 illustrates an example of device 500, similar to or the same as device 100 (FIG. 1) including additional optional component details as those shown in Figure. In one implementation, device 500 may include processor 502, which may be similar to processor 102 for carrying out processing functions associated with one or more of components and functions described herein. Processor 502 can include a single or multiple set of processors or multi-core processors. Moreover, processor 502 can be implemented as an integrated processing system and/or a distributed processing system.

Device 500 may further include memory 504, which may be similar to memory 104 such as for storing local versions of applications being executed by processor 502, such as auto-fill application 120, an operating system (or other components thereof), applications, related instructions, parameters (e.g., in auto-fill repository 132), etc. Memory 504 can include a type of memory usable by a computer, such as random access memory (RAM), read only memory (ROM), tapes, magnetic discs, optical discs, volatile memory, non-volatile memory, and any combination thereof.

Further, device 500 may include a communications component 506 that provides for establishing and maintaining communications with one or more other devices, parties, entities, etc., utilizing hardware, software, and services as described herein. Communications component 506 may carry communications between components on device 500 (e.g., display device 108), as well as between device 500 and external devices, such as devices located across a communications network and/or devices serially or locally connected to device 500. For example, communications component 506 may include one or more buses, and may further include transmit chain components and receive chain components associated with a wireless or wired transmitter and receiver, respectively, operable for interfacing with external devices.

Additionally, device 500 may include a data store 508, which can be any suitable combination of hardware and/or software, that provides for mass storage of information, databases, and programs employed in connection with implementations described herein. For example, data store 508 may be or may include a data repository for applications and/or related parameters (e.g., auto-fill application 120, an operating system 106 (or other components thereof), auto-fill repository 132, applications, etc.) not currently being executed by processor 502. In addition, data store 508 may be or include a data repository (e.g., auto-fill repository 132) for auto-fill application 120, an operating system (or other components thereof), applications, and/or one or more other components of the device 500.

Device 500 may include a user interface component 510 operable to receive inputs from a user of device 500 and further operable to generate outputs for presentation to the user. User interface component 510 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof.

Device 500 may additionally include and/or be communicatively coupled with an auto-fill application 120, auto-fill repository, etc. for providing the auto-fill functionalities described herein.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more implementations, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various implementations described herein. Various modifications to these implementations will be readily apparent to those skilled in the art, and the generic principles defined herein may be applied to other implementations. Thus, the claims are not intended to be limited to the implementations shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various implementations described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A computer implemented method for populating input fields on an application, comprising:
storing, via the application, auto-fill data for form input fields including multiple data input used in populating one or more form input fields;
detecting, via the application, a form input field of a form rendered by the application;
determining that the stored auto-fill data does not include a data input for a form input field type of the form input field;
determining a data class associated with the form input field;
generating, based on the data class and based on determining that the stored auto-fill data does not include the data input, an anticipatory response, that includes input previously obtained by one or more different applications other than the application, for populating the form input field; and
populating, via the application, the form input field of the form with the anticipatory response.

2. (canceled)

3. The computer implemented method of claim 1, wherein the one or more different applications include a productivity application.

4. The computer implemented method of claim 1, wherein the one or more different applications include a webpage rendered on a web browser application.

5. The computer implemented method of claim 1, further comprising storing the input from the one or more different applications in a repository and as associated with the data class, wherein generating the anticipatory response is based at least in part on obtaining the input from the repository based on the data class.

6. The computer implemented method of claim 5, further comprising removing the input from the repository based on one or more detected events.

7. The computer implemented method of claim 6, wherein the one or more detected events correspond to at least one of exiting the application or a detected occurrence of a date and/or time.

8. The computer implemented method of claim 6, wherein the one or more detected events are defined based at least in part on the data class.

9. The computer implemented method of claim 5, wherein storing the input from the one or more different applications comprises mining accessible webpages for possible input data for the data class.

10. A device for populating input fields on an application, comprising:
a memory storing one or more parameters or instructions for generating anticipatory responses for form input fields; and
at least one processor coupled to the memory, wherein the at least one processor is configured to:
store, via the application, auto-fill data for form input fields including multiple data input used in populating one or more form input fields;
detect, via the application, a form input field of a form rendered by the application;
determine that the stored auto-fill data does not include a data input for a form input field type of the form input field;
determine a data class associated with the form input field;
generate, based on the data class and based on determining that the stored auto-fill data does not include the data input, an anticipatory response, that includes input previously obtained by one or more different applications other than the application, for populating the form input field; and
populate, via the application, the form input field of the form with the anticipatory response.

11. (canceled)

12. The device of claim 10, wherein the one or more different applications include a productivity application.

13. The device of claim 10, wherein the one or more different applications include a webpage rendered on a web browser application.

14. The device of claim 10, wherein the at least one processor is further configured to store the input from the one or more different applications in a repository and as associated with the data class, wherein the at least one processor is configured to generate the anticipatory response based at least in part on obtaining the input from the repository based on the data class.

15. The device of claim 14, wherein the at least one processor is further configured to remove the input from the repository based on one or more detected events.

16. The device of claim 15, wherein the one or more detected events correspond to at least one of exiting the application or a detected occurrence of a date and/or time.

17. The device of claim 15, wherein the one or more detected events are defined based at least in part on the data class.

18. The device of claim 14, wherein the at least one processor is configured to store the input from the one or more different applications at least in part by mining accessible webpages for possible input data for the data class.

19. A non-transitory computer-readable medium, comprising code executable by one or more processors for populating input fields on an application, the code comprising code for:
storing, via the application, auto-fill data for form input fields including multiple data input used in populating one or more form input fields;
detecting, via the application, a form input field of a form rendered by the application;
determining that the stored auto-fill data does not include a data input for a form input field type of the form input field;
determining a data class associated with the form input field;
generating, based on the data class and based on determining that the stored auto-fill data does not include the data input, an anticipatory response, that includes input previously obtained by one or more different applications other than the application, for populating the form input field; and
populating, via the application, the form input field of the form with the anticipatory response.

20. (canceled)

21. The non-transitory computer-readable medium of claim 19, wherein the one or more different applications include a productivity application.

22. The non-transitory computer-readable medium of claim 19, wherein the one or more different applications include a webpage rendered on a web browser application.

23. The non-transitory computer-readable medium of claim 19, further comprising code for storing the input from the one or more different applications in a repository and as associated with the data class, wherein the code for generating the anticipatory response is based at least in part on obtaining the input from the repository based on the data class.
